(19) United States
(12) Patent Application Publication
(10) Pub. No.: US 2010/0092716 A1
(43) Pub. Date: Apr. 15, 2010

(54) LABEL WITH ADHESIVE SURFACE

(76) Inventor: Joseph J. Spychalsky, Palm Bay, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/251,393

(22) Filed: Oct. 14, 2008

(51) Int. Cl. B32B 33/00; B32B 3/10; B32B 38/00

(52) U.S. Cl. 428/41.8; 428/195.1; 156/280

(57) ABSTRACT

A self-adhering label for application to the sidewall of cured and vulcanized wheeled-vehicle tire. The label comprises a display layer comprising a natural rubber or a synthetic rubber material, an image carried by a first surface of the display layer, the image further comprising visible text or a graphical image formed from an ink having expandable and contractible properties and an adhesive layer applied to a second surface of the display layer, the second surface opposite the first surface, the adhesive layer having expandable and contractible properties similar to the display layer.

This patent application claims the benefit under Section 119(e) of the provisional patent application assigned Application No. 60/679,839 filed on Oct. 14, 2007.

### FIELD OF THE INVENTION

The present invention relates to a label with an adhesive surface.

### BACKGROUND OF THE INVENTION

It is known that certain labels may not adhere to certain surfaces for long periods of time, especially those subjected to a harsh environment, such as an automobile tire. When in use, tires are subjected to rain, wind, environmental contaminants, sidewall flexing (due to expansion and contraction caused by heating and cooling, and also due to abnormalities in the road surface) and forces exerted on the tire as it rotates and the vehicle weight shifts.

Thus it is desired for a label to withstand these environmental effects and forces and further provide a surface on which a logo or text can be placed.

### BRIEF DESCRIPTION OF THE DRAWINGS

The present invention can be more easily understood and the advantages and uses thereof more readily apparent when the following detailed description of the invention is read in conjunction with the figures wherein:

FIG. 1 is perspective view of a label according to the present invention

FIG. 2 is a cross-sectional view of the label of FIG. 1.

In accordance with common practice, the various described features are not drawn to scale, but are drawn to emphasize specific features relevant to the invention. Like reference characters denote like elements throughout the figures and text.

### DETAILED DESCRIPTION OF THE INVENTION

Before describing in detail exemplary labels and associated adhesive surfaces, it should be observed that the present invention resides primarily in a novel and non-obvious combination of elements. So as not to obscure the disclosure with details that will be readily apparent to those skilled in the art, certain conventional elements have been presented with lesser detail, while the drawings and the specification describe in greater detail other elements pertinent to understanding the invention.

The following embodiments are not intended to define limits as to the structure of the invention, but only to provide exemplary constructions. The described embodiments are permissive rather than mandatory and illustrative rather than exhaustive.

In accordance with this invention, generally stated, a label is provided having a first surface on which information is printed, silk-screened or embossed and a second surface, oppositely-disposed from the first surface, comprising an adhesive surface with relatively strong bonding characteristics, for example, to rubber compounds and rubber-like materials.

Prior to attaching the label to an intended surface, a peelable or lightly-adhering releasable layer adheres to the second (adhesive) surface. The releasable layer comprises a thin film or kraft paper for protecting the adhesive surface prior to use of the label. After assembly, the label (comprising the first surface and the second surface) and the releasable layer are die cut, kiss cut, laser cut, water jet cut or the like to achieve the desired label shape and to form a grasping edge of releasable layer material around the perimeter of the label to aide in removal of the releasable layer.

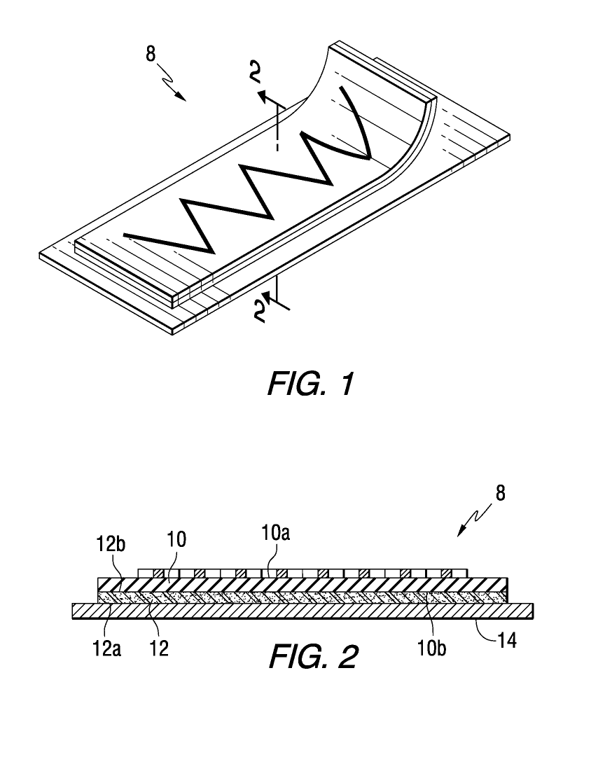

Referring to FIGS. 1 and 2, a label 8 of the present invention comprises a laminated construction of a display layer 10 for receiving text, icons, figures or graphical elements on an exposed surface 10A, and an adhesive layer 12 having a rubber or an acrylic-based adhesive material on its exposed surface 12A. The surface 12A of the adhesive layer attaches the label 8 to a surface of an article.

As shown in FIGS. 1 and 2, the surface 12A of the adhesive layer 12 loosely or peelably adheres to a releasable layer 14 prior to attaching the label 8 to the intended surface. The surface 12A adheres to the releasable layer 14 with considerably less affinity than a surface 12B of the layer 12 adheres to a surface 10B of the layer 10. Thus, the adhesive layer 12 attaches to the display layer 10 with more holding force than the adhesive layer 12 attaches to the releasable layer 14. One can therefore easily peel the releasable layer 14 from the surface 12A.

When the label 8 is removed from the releasable layer 14, the adhesive surface 12A is exposed and can be applied to another surface, for example, the sidewall of a wheeled-vehicle tire, such as a tire for an automobile, motorcycle, golf cart, lawn mower, bicycle and a trailer. When applied to such a surface, the image on the surface 10A is visible. Application of the label 8 to the vehicle tire sidewall does not require any preparation of the intended surface.

In a preferred embodiment the layer 10 of label 8 comprises a rubber compound to permit the layer 10 to move, stretch and deform with a rubber surface to which the label 8 is adhered. The thickness of the layer 10 may range between about 0.020 and about 0.040 inches and preferably is about 0.030 inches thick. Generally, it is desirable for the adhesive layer 12 to exhibit stretch and deformation properties similar to those properties of the layer 10.

The surface 10A of the layer 10 is formulated and prepared to accept printed material according to a silk screen process, an offset printing process, a laser printing process, a bubble jet printing process, a hot stamp process, an ink stamp process or another suitable printing process. An image is printed on the exposed surface 10A using any one of those techniques or with ink in the traditional manner.

The layer 10 of the label 8, may be made of a natural or synthetic rubber compound that resists abrasion and degradation by UV radiation or heat above 180° F. Natural latex rubber sheet, which is sold by Aero Rubber of Tinley Park, Ill., is one example of a suitable rubber compound for the layer 10.

In a preferred embodiment the layer 10 comprises a natural latex rubber compound loaded with carbon black and oils to create a uniformly black color. A black color for the layer 10 was selected to blend with the intended surface on which it is to be bonded, i.e., a tire. A natural tan rubber could have been used and printed with a black material, but the tan material reveals tan edges after the labels are cut from a sheet. The carbon black also adds a UV inhibitor which extends the life of the label when used outdoors in sunlight. Also, it has been determined that adding the carbon black and the oils aides the cutting process, as these materials tend to break apart the long fibers of the natural rubber.

In tire applications a natural rubber compound may be preferable since its physical properties closely match the physical properties of the tire rubber. But use of such a material limits the available adhesives. Natural rubber has an extremely high elongation factor (stretches by up to about 500%) and offers a high rip or tear resistance. The natural rubber, when blackened as described above, resists UV radiation and therefore has a longer life in full sun exposure for extended periods.

The inventor determined that commercially available rubber ink from Union Process of Akron, Ohio adhered well to the natural rubber and did not crack or peel in use and under stress. Generally, a combination of the black natural rubber and a rubber ink appeared to yield the best results.

The adhesive layer 12 may range between about 0.003 and about 0.010 inches in thickness and preferably is about 0.008 inches thick. Preferably, the adhesive layer 12 covers the entire surface 10B of the layer 10. The adhesive layer 12 has a considerably higher affinity for the material of the layer 10 than for the releasable layer 14, and thus can be peeled away from the releasable layer 14 while remaining attached to the layer 10.

In one embodiment the adhesive of the adhesive layer 12 is acrylic-based, and as such is suitable for adhering to rubber surfaces such as tire sidewalls. Suitable candidates for the adhesive layer 12 include an adhesive from the 300 MP family of acrylic adhesives offered by the 3M Company of St. Paul, Minn. One suitable adhesive layer comprises 3M part number 6038PC, where the 6038 refers to a 3M adhesive family and a thickness of 8 mils. The PC in the part number refers to a paper carrier included with the adhesive layer, e.g., a heavy Kraft paper.

The adhesive layer 12 comprises preferably a pressure-sensitive material that is made to adhere to the layer 10 by the application of pressure. Other adhesives, such as two-part adhesives (i.e., two chemicals mixed to cause a reaction, such as epoxies) and solvent-based adhesives (i.e., that create a bond by evaporation of the solvent allowing the adhesive to harden) may also be employed. The pressure sensitive adhesives are preferred to simplify the application of the label 8 to the intended surface, such as a tire. Although other adhesives may be suitable, the combination of a high quality bond and ease of use makes the pressure-sensitive material a good choice.

The adhesive layer 12 exhibits suitable strength to resist the extreme acceleration experienced by an object rotating in a circular path with a diameter of about 18 inches at a rate of about 120 feet per second, e.g., an automobile tire. The adhesive layer 12 should be capable of accepting no less than about 0.30 pounds per square inch of pressure. The adhesive layer 12 is also resistant to water and does not degrade due to contact experienced in use or immersion in water for a period of time not to exceed about 48 hours. An adhesive material referred to above exhibits these desirable properties.

In one embodiment the adhesive layer 12 comprises an acrylic-based adhesive selected primarily for its affinity for low surface energy surfaces and its high operating temperature range (up to about 250° F.).

In one embodiment the adhesive comprises a double-sided tape of sufficient thickness to adhere over an irregular surface, such as the sidewall surface of a tire. The selected adhesive lacks a polyester carrier, found in most double-sided tapes, because the carrier prevents the adhesive from stretching properly with an elongation percentage to approximately match the elongation percentage of the rubber compound of the layer 10.

The rubber adhesive layer 12 is bonded to substantially the entire surface 10B. It has been determined that the rubber of the display layer 10 continues to cure for up to about six weeks after manufacture. The volatile chemicals blooming from the surface of the uncured rubber cause the adhesive to fail prematurely and thus break the bond between the display layer 10 and the adhesive layer 12.

A process to laminate the adhesive layer 12 to the display layer 10 has been developed. The display layer 10 is fully cured for a period no less than about four weeks. The surface 10B of the display layer 10 is then cleaned with a 50/50 solution of isopropyl alcohol and distilled water and dried. The 50/50 solution cleans the surface of oils and chemicals and neutralizes the surface in preparation for application of a primer. A primer/sealer, such as 3M part number 94 is applied to the surface 10B. Any primer that activates the rubber surface 10B and seals the surface's microscopic pores is suitable for use according to this process. The primer effectively creates a barrier between the material of the display layer surface 10B and the adhesive layer surface 12B.

The adhesive material is applied to the display layer 10 by squeezing the assembly between application rollers under a minimum pressure of between about 2-5 psi and at a slightly elevated temperature of greater than about 75 degrees F. A pressure that does not cause the display layer 10 from expanding during the application process is acceptable. It was found that in the absence of the pressure, if the rubber was allowed to expand longitudinally during application of the adhesive, the rubber will contract after the application is completed. This contraction causes the adhesive to pucker and ripple creating small voids and bubbles between the display layer surface 10B and the adhesive layer surface 12B. The voids and bubbles cause the layers 10 and 12 to separate and the label 8 to fail prematurely. The application of heat helps to activate the adhesive and create a better bond to the primed surface of the layer 10. It was observed that prior to instituting the laminating process described herein, the adhesive released from the rubber after a short time not suitable for a viable tire sidewall label.

The primary use of the preferred embodiment of the present invention is a label for adhering to the sidewall of automobile tires (or any other rubber-based tires, such as bicycle tires). The materials selected, the manner in which the label is manufactured and the manner in which it is applied to the preferred surfaces are designed to withstand the harsh environment of an automobile tire in use at highway speeds. Application of the label 8 to the tire sidewall involves simply removal of the releasable layer 14 and application of the surface 12A of the adhesive layer 12 to the tire sidewall.

The label 8 of the present invention must be sufficiently flexible to withstand the cyclical expansion and contraction of the tire sidewall as the tire rolls along the road surface. On every revolution the tire sidewall expands as the weight of the vehicle bears down on the tire and flattens the tire's circumferential surface, forcing the adjacent sidewall surface to expand outwardly. As the tire rotates, the tire sidewall contracts as the flattened tire surface losses contact with the road and the load is transferred to another region of the tire circumference.

The material of the various layers of the label 8 are also sufficiently flexibly thin to conform to the any surface features present on the tire sidewall surfaces. Tires are embossed with characters and designs leaving few large and smooth surfaces upon which to adhere the preferred embodiment of the invention. Thus the label must be designed to adhere (for an extended period) and conform to the surface features present on automobile tire sidewalls.

The surface 12A of the adhesive layer 12 that is attached to the tire sidewall is heated as the tire rotates. Heat from the roadway and friction generated by air particles moving inside the tire elevate the temperature on the sidewall surface to a maximum temperature of about 180° F. in extreme use. Thus the layers 10 and 12 (and the printed media on the surface 10A) must withstand a temperature greater than about 180° F.

The preferred embodiment of the invention will also be exposed to extreme acceleration and high shear and peel forces when applied to a tire sidewall surface. The surface on which the preferred embodiment of the label is to be applied rotates at high rates of speed around a fixed axis. The experienced acceleration can reach about 1800 ft/s². The preferred embodiment must resist a force causing the label to peel from the adhering surface equal to its mass multiplied by the acceleration. The force is evenly distributed over the surface area of the label. The adhesive layer 12 provides a retaining pressure of at least about 0.30 pounds per square inch to resist the force of centripetal acceleration.

Wind forces also attempt to peel the preferred embodiment of the label from the sidewall surface of the tire. The wind force is equal to the square of the wind velocity multiplied by the density of air and the surface area of the label. The magnitude of the force due to wind is considerably less than the force due to acceleration and as such does not significantly increase the required retaining pressure of the adhesive layer 12.

The adhesive layer 12 is resistant to incidental exposure to water and chemicals blooming from the surface to which the label is attached. Tires are regularly exposed to water during use. The adhesive layer 12 must not dissolve or otherwise significantly degrade when exposed to water. Many different chemicals are used in the manufacture of automobile tires. These chemicals bloom and rise to the surface throughout the life of the tire. The adhesive layer 12 must be resistant to the blooming chemicals and not loosen during use.

Ultra violet radiation degrades and breaks down many materials over time. The rubber layer 10, the adhesive layer 12 and the printed media must be tolerant of UV radiation for the intended service life of the label 8. In one embodiment of the label 8, the inventor has selected materials that will permit the label to remain in place and the printed media not significantly degraded (i.e., to the point where the print cannot be recognized) for approximately 6 months.

The materials of the printable layer of prior art labels used for application to similar rubber-based products (such as automotive applications) fail when applied to the sidewall surfaces of tires due to the harsh environment in which they are expected to function. Vinyl and other plastics fracture and crack when stretched. Historically sidewall text and designs and semi-permanent labels must be introduced to the tire in the “green” or uncured state. Then the prior art label, text or design is vulcanized with the tire to make to create a unitary structure. On the contrary, the preferred embodiment of the present invention is designed as a post-cure application.

Thus the label of the present invention does not need to be vulcanized with the tire to adhere to the tire surface. In addition the label of the preferred embodiment of the invention is intended to be a non permanent addition to the sidewall and may be removed and changed as frequently as desired. Prior art designs, lettering, stripes, text and the like, that are vulcanized with the tire cannot be removed.

While the invention has been described with reference to various embodiments thereof, it will be understood by those skilled in the art that various changes may be made and equivalent elements may be substituted for elements thereof without departing from the scope of the present invention. The scope of the present invention further includes any combination of the elements from the various embodiments set forth herein. In addition, modifications may be made to adapt a particular situation to the teachings of the present invention without departing from its essential scope. Therefore, it is intended that the invention not be limited to the particular embodiment disclosed as the best mode contemplated for carrying out this invention, but that the invention will include all embodiments falling within the scope of the appended claims.

What is claimed is:

1. A self-adhering label for application to the sidewall of cured and vulcanized wheeled-vehicle tire, the label comprising:
a display layer comprising a natural rubber or a synthetic rubber material;
an image carried by a first surface of the display layer, the image further comprising visible text or a graphical image formed from an ink having expandable and contractible properties; and
an adhesive layer applied to a second surface of the display layer, the second surface opposite the first surface, the adhesive layer having expandable and contractible properties similar to the display layer.

2. The label of claim 1 wherein the display layer further comprises carbon black.

3. The label of claim 1 wherein the image comprises ink in a predetermined pattern on the first surface of the display layer, and wherein the ink is transferred by printing, silk screening or embossing.

4. The label of claim 1 wherein the ink comprises an ink suitable for use on natural rubber or synthetic rubber.

5. The label of claim 1 wherein the image comprises at least one of a picture, a letter, a symbol or a pattern.

6. The label of claim 1 further comprising a peelable layer attached to a free surface of the adhesive layer and removed prior to application of the label to the sidewall.

7. The label of claim 1 wherein the adhesive layer comprises a pressure sensitive material attached to the display layer by the application of pressure of between about two and five psi and at an elevated temperature of about at least 75 degrees F.

8. The label of claim 1 wherein the label is applied to the tire by bringing the adhesive layer into contact with the sidewall.

9. The label of claim 1 wherein the display layer has a thickness between about 0.040 inches and 0.015 inches.

10. The label of claim 1 wherein the adhesive layer has a thickness of between about 0.003 and about 0.010 inches.

11. The label of claim 1 wherein the display layer is black in color and a shape of the label is determined by a shape of the image.

12. The label of claim 1 wherein the adhesive layer comprises acrylic having expandable and contractible properties substantially similar to the expandable and contractible properties of the vehicle tire;

13. The label of claim 1 wherein the adhesive layer adheres to a sidewall material having a low surface energy.

14. The label of claim 1 substantially conforming to the sidewall of the tire with raised text and images formed in the sidewall.

15. A method for manufacturing a self-adhering label for application to the sidewall of a cured and vulcanized wheeled-vehicle tire, the method comprising:
forming a display layer from a material having expandable and contractible properties substantially similar to the expandable and contractible properties of the vehicle tire;
curing the display layer for about four weeks;
cleaning a first surface of the display layer with a solution of isopropyl alcohol and distilled water;
applying a primer to the first surface of the display layer;
laminating the display layer and a pressure-sensitive adhesive layer by passing the display layer and the adhesive layer between application rollers, the adhesive layer in contact with the first surface of the display layer, the adhesive layer having expandable and contractible properties similar to the display layer; and
forming an image on a second surface of the display layer by application of a rubber ink to the second surface;

16. The method of claim 15 wherein the step of laminating is executed under a pressure between about two and five psi and at a temperature of greater than about 75 degrees F.
